(19) United States
(12) Patent Application Publication
(10) Pub. No.: US 2005/0038790 A1
(43) Pub. Date: Feb. 17, 2005

(54) Device and method for establishing a security policy in a distributed system

(76) Inventor: Stephen Wolthusen, Buerstadt (DE)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/489,817

(22) PCT Filed: Sep. 17, 2002
(86) PCT No.: PCT/EP02/10437

(30) Foreign Application Priority Data
Sep. 20, 2001 (DE) 10146361.8

(51) Int. Cl. G06F 17/00

(52) U.S. Cl. 707/100

(57) ABSTRACT

The invention relates to a distributed system comprised of a multitude of computer units, so-called nodes, which are connected to one another over a network and inside of which a local monitoring unit is provided for applying at least one security policy incumbent upon the respective nodes. Said monitoring unit is connected to at least one external monitoring unit, which is located within the network and inside of which systems of rules concerning the security policies of all nodes or of at least one group of nodes can be stored. The invention also relates to a method for operating a distributed system of the aforementioned type. The invention is characterized in that the local monitoring unit is a reference monitor (ECRM=Externally Controlled Reference Monitor) that, at the operation system level of the respective node, controls all operations with objects and interactions between subjects and objects within the nodes based on the system of rules that is at least temporarily implemented in the reference monitor (ECRM) of the respective node.

### TECHNICAL BACKGROUND

The present invention relates to a distributed system comprising a multitude of computer units, so-called nodes, which are interconnected via a network and in each of which a local monitoring unit is provided for applying at least one security policy incumbent upon the respective nodes, which are connected inside the network to at least one external monitoring unit, in which systems of rules relating to the security policies of all nodes or of at least one group of nodes can be stored. Furthermore, the present invention relates to a method for applying a security policy in a multitude of computer units which are interconnected via a network.

### PRIOR ART

The trend towards increased networking of computer systems and practically every other electronic device is generally not questioned. Combined with the constantly growing dependency of such type distributed systems respectively networks and the growing importance and sensitivity of the data and applications utilized in these structures, the need for mechanisms to force the creation of guidelines for security and integrity is obvious.

However, it must be noted that the presently available and employed systems ranging from operating systems to firewalls do not meet these requirements. Furthermore, many application programs have been developed to support networks or have been expanded with regard thereto, but considerations relating to the security of this application are generally not effectively integrated.

Therefore, what seems necessary is a pragmatic mechanism in order to at least partially meet these demands and at the same time to ensure as far as possible compatibility with the existing systems, which can be achieved by retrofitting conventional operation systems with the required mechanisms, if one is prepared to tolerate a lower degree of confidentiality than would be the case with a completely realized system.

The primary challenge is that such a type mechanism must operate across node boundaries and system boundaries in order to be able to offer a comprehensive security solution in a heterogeneous network environment and that this security mechanism must not cause or require any modifications of the existing application programs. Last but not least, such a type mechanism must also remain as invisible as possible to users if they keep within the boundaries set by the valid security policy.

Another criterion for the development of such a type security system must be that it is neutral with regard to the to-be-enforced security policy (respectively the security model).

Another aspect is communication between different subjects, i.e. computer units, respectively nodes or users, all of which equipped with different security standards. It must be assumed that, for example, a mobile device may, while forming an unanticipated transitive network, contact a to-be-secured node. A similar scenario is when a user sets up a remote access connection to a secure network and has at the same time set up another network and thus has, usually unintentionally, set up an insecure connection between the public internet and a fundamentally secure network and in doing so has deactivated all protection and protocol mechanisms.

Trojan horses of varying complexity down to complete remote maintenance tools represent another threat to be classified as a mobile program code. As execution of such type programs often occurs based on social factors, the technical means provided for protection thereof are inadequate.

Even a simple current www-application usually contains a complex multitude of protocols and applications of modern HTML interpreters and representation processes, which themselves may already be vulnerable and furthermore may cause implicit operations by the receiving nodes including execution of codes. Only very little of this is perceived by the users or can only be selectively controlled and deactivated by them.

A system solving the preceding problem, however only partial aspects thereof, is given in U.S. Pat. No. 6,202,257, which describes a system comprising a multitude of network-connected computer nodes which are provided with security rules, which correspond to a supervisor security policy, for executing certain application programs on the respective node by a supervisor central authorization unit.

A security policy, which however is restricted only to one application, respectively one application program, as is the case in the aforementioned printed publication, can for example not prevent a semantically equivalent operation from being executed with a second application, for example sending an e-mail that is not subject to the security policy.

If, in addition, a Trojan horse has been installed on the respective node, it is an easy matter for this program procedure to remove data from the “secured” application area subject to the security policy, respectively by reading out the contents of the storage or the data utilized by the “secured” application.

In conclusion it can, therefore, be said that the gain in security by protecting one single application program or even a part of all application programs is extremely unsatisfactory as only attacks on the communication channels between the secured applications can be warded off, prior-art aids do not address attacks by inside adversaries, by Trojan horses, or attacks on the nodes themselves are not addressed.

### SUMMARY OF THE INVENTION

The object of the present invention is to further develop a distributed system comprising a multitude of computer units, so-called nodes, which are interconnected via a network and in each of which a local monitoring unit is provided for applying at least one security policy incumbent upon the respective nodes, which are connected inside the network to at least one external monitoring unit, in which systems of rules relating to the security policies of all nodes or of at least one group of nodes can be stored, in such a manner that the resources present in a node are secure against uncontrolled and unauthorized access and tampering. Resources refers to all files, such as executable files and data files including lists, connections, virtual connections, datagrams, interprocess communication messages, devices, physical connection as well as memory segment.

The solution of the object of the present invention is the subject matter of claim 1. An invented method is the subject matter of claim 18. The features that advantageously further develop the inventive idea are the subject matter of the sub-claims as well as of the description.

A key element of the present invention is that a distributed system comprising a multitude of computer units, so-called nodes, interconnected via a network and in each of which a local monitoring unit is provided for application of at least one security policy incumbent upon the respective nodes, which are connected inside the network to at least one external monitoring unit, in which systems of rules relating to the security policies of all nodes or of at least one group of nodes can be stored, is designed in such a manner that the local monitoring unit is a reference monitor (ECRM=externally controlled reference monitor), which controls, on the operation system level of the respective node, all operations with objects and all interaction between subjects and objects inside the node based on a system of rules, which is at least temporarily implemented in the reference monitor (ECRM); the ECRM serves solely to enforce the security policy, which is applied from the outside and does not need to be completely present inside the ECRM. To the extent the ECRM is confronted with a situation for which no temporarily applied rules are available, the ECRM must automatically implicitly request the rules to be applied.

The term security policy is confined herein to a definition which only contains rules and which is realizable using technical means. Single aspects covered by such type rules contain all operations by the subjects as users, by application programs acting on behalf of users or by the behavior of the node operating system itself. Wherever possible, a security mechanism must try to couple such type operations to the recognizable semantically supreme instance, i.e. in the most favorable case to a specific user.

The term reference monitor concept comes from J. P. Anderson's article “Computer Security Technology Planning Study”, Tech. Rep. ESD-TR-73-51, Air Force Electronic Systems Division (AFSC), L. G. Hanscom Field, Bedford, Mass., October 1972, AD-758 206, ESD/AFSC to whose disclosure content reference is and will be referred herein.

The goal of the aforementioned solution is to enforce the mechanisms of a supervisor security policy inside each single node on the level of the node-determining operating system which controls access to all objects, i.e. to all the resources available on the respective nodes, by random subjects respectively by the user him/herself. By at least one superior monitoring unit networking the single nodes and placing at disposal one or a multitude of security policies for each single node or group of nodes, the security policies become effective beyond the operating boundaries of each single node and ultimately remain in the background for the user and for the application programs running on the single nodes without impairing the convenience or functionality of their operation.

An essential key to realizing this goal is the separation of decisions relating to security policies and their enforcement, both on the level of single respective nodes as well as between nodes which realize the enforcement of such a type security policy and nodes which specify a security policy.

The principle of separating the security policy from its enforcement may be viewed as generally accepted (see O. Saydjari, S. Turner, D. Peele, J. Farrell, P. Loscocco, W. Kurtz, G. Bock: “Synergy: A Distributed, Microkernel-based Security Architecture”, a report by the US National Security Agency, Fort George G. Meade, Md., November 1993). Although this principle was originally intended for use inside a single node, according to the present invention it is proposed applying the same principle to a distributed system. Enforcement of the security policy occurs on the level of the respective operating system of single nodes and on the basis of decisions which are either received directly from a node distributing a security policy or are temporarily derived from a security policy locally delegated by such a node.

The thus achieved separation between user nodes which enforce security policies and nodes which control security policies can be realized using externally controlled reference monitors (ECRM). Suited balancing between centralized decisions and delegated elements of the overall security policy can keep the resulting network load tolerable, which in this instance is primarily determined by the response periods and not by the bandwidths.

The ECRM mechanism is based on the separation of decisions relating to the security policy from their application by dividing the reference monitor into local components, which are contained in each user node (ECRM), and into external distributing centers for security policies, the external reference monitors (ERM). Both the core functionality of the ERM and of the ECRM can be stored in secure coprocessors to increase confidentiality and increase protection against manipulation.

The ERM nodes contain information relating to security policies for which they either are authorized to make decisions or act as temporary caches. Employing a suited mechanism to resolve conflicts in security policies also permits regulating the handling of operations stemming from subjects or objects from several different areas of responsibility of the security policies. Communication between an ECRM and an ERM may relate to both single decisions, such as for example access to a data object for precisely one access, as well as to temporary delegation in a derived subset of the active security policy, depending, among other things, on the type of desired operation and the capabilities of the ECRM node.

A special invented element is that the ERM provides the ECRM, i.e. the local reference monitor, with a security policy represented as a system of rules, which the ECRM adopts on the operating system level and applies for decision-making relating to operations using the means of formal logic of the first order. The formal logic of the first order ensures that the to-be-made decisions are always self-consistent and are not in contradiction with the overall distributed system.

In addition to enforcing a uniform security policy on all the distributed nodes, the security policy can also be hierarchically structured. The basic condition for maintaining

security within the distributed system is that subordinate policies, that is more restricted security policies, may solely contain additional restrictions in their system of rules.

If subjects, such as for example users, processes, application programs, nodes, networks, network links, bus links, and objects, for example data, executable files, data files, lists, connections, virtual connections, datagrams, interprocess communication messages, devices, physical connections and memory segments, a multitude of organizations, respectively firms, overlap with regard to the rules, a solution mechanism for correct handling of this situation with possibly contradictory rules in the individual, respective security policies is required. This mechanism must be defined individually for all the respective organizations by the respective security administrators. In this case, it is therefore necessary to enforce the entire set of all the active policies consistently over the entire distributed system. If policy rules are coupled to semantically superior subjects, each unit that makes such decisions or regulates such operations must know these consolidated rules.

If one is prepared to tolerate delays between specification and implementation of the rules, additional ERM nodes can be employed both as caches for load distribution and locally at the ECRM to temporarily store rules intermediately for application. The delay of this application can be regulated by means of specification of the lifetime of a rule; after termination of the lifetime, the origin of the rule must be contacted and the request on the basis of which the rule was created must be repeated.

Furthermore, an element of the present invention is to further develop a method for applying a security policy in a multitude of nodes, which are interconnected via a network and in each of which a local monitoring unit is provided and which are connected in the network to at least one external monitoring unit, in which the security policies of all nodes or at least the system of rules of a group of nodes are stored in such a manner that a system of rules determining the security policy can be retrieved by at least one external monitoring unit and stored at least temporarily inside the node and processed in such a manner that this system of rules controls on the operating system level of the node all operations with the objects and all interactions between subjects and objects inside the node subject to the system of rules.

In addition to the terms subjects and objects already explained in the preceding, the term operations refers inside a computer unit to the following functions in process: compiling files, reading a file, writing a file, overwriting a file, adding a file, deleting a file, reading the metainformation of a file, writing the metainformation of a file, compiling a list, reading a list, searching in a list, deleting a list, creating a memory segment, reading a memory segment, writing a memory segment, deleting a memory segment, opening a device, writing data on a device, reading metadata of a device, writing metadata on a device, shutting down a device, transmitting interprocess communication messages, receiving interprocess communication messages, transmitting a datagram, receiving a datagram, creating a virtual connection, transmitting data via a virtual connection, receiving data via a virtual connection, removing a virtual connection.

The invented method and the preceding device are described in more detail in the following with reference to a concrete preferred embodiment:

### BRIEF DESCRIPTION OF THE DRAWING

The present invention is made more apparent in the following, by way of example, using a preferred embodiment with reference to the drawing without the intention of limiting the scope or spirit of the overall inventive idea.

FIG. 1 shows an externally controlled reference monitor model.

### WAYS TO CARRY OUT THE INVENTION, COMMERCIAL APPLICABILITY

A distributed system should guarantee the overall security homogeneously with reference to the security policies to be enforced and their realization. To do so, the following conditions must be met:
1. The control mechanism required by the reference monitor should be secured against tampering from the outside.
2. The control mechanism required by the reference monitor should be queried in every operation.
3. The control mechanism required by the reference monitor should be small enough to be able to be subjected to analyses and checks, which verify the assurance of the demanded characteristics.

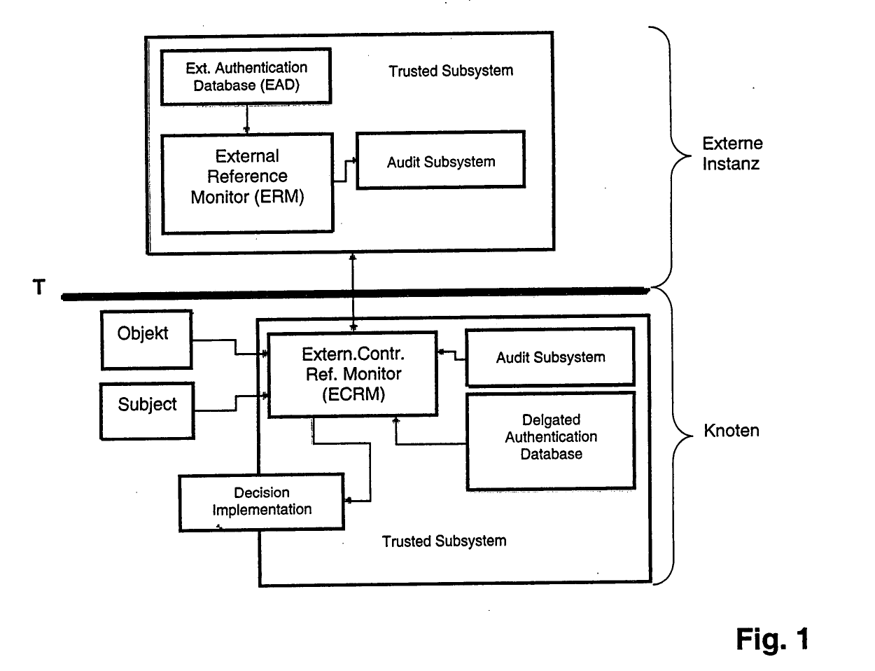

A distributed system which fulfills all three above requirements and, in particular, meets requirement 2 is described in the following with reference to FIG. 1.

The separating line T in FIG. 1 characterizes the physical separation between a (end) node and an external instance (server), which intercommunicate via a network connection or via an alternative connecting method. On both the node side and on the server side, in lieu of the individual computer units in each case a multitude of external instances including, in particular, nodes are added, not depicted for reasons of clarity.

The node is provided with an externally controlled reference monitor (ECRM), which determines the security policy on this computer on the basis of rules, makes decisions regarding all operations running on this node, for example, operations relating to the manipulation of objects (object identity) as a result of entries by subjects (subject identity). The subsequent decisions are made accessible via a readout unit (decision implementation) to the operating system of the node for corresponding execution or non-execution of the respective operation.

The security policy, which can be represented in the form of a system of rules, can in certain cases, which will be dealt with separately, be intermediately stored in a cache (delegated authentication database). In addition, the node contains a sort of audit subsystem, which detects and records communication between the node and the external instance and/or operations between subjects and/or objects running inside the node. This aspect will also be taken up in more detail later on.

On the other hand, the external instance provides an external reference monitor (ERM). Incumbent on the external reference monitor is a security policy, in the form of a system of rules, relating to all the nodes connected to the external instance, provided as an authentication database. Like the node, the server is also provided with an audit subsystem.

For security reasons against attacks from outside, i.e. by unauthorized entry by third parties, into the distributed system, the node and the external instance are integrated in a secure coprocessor (trusted subsystem).

An essential aspect of fulfilling the requirements set in the preceding is to store the authentication database outside the individual nodes and to have the reference monitors of the nodes (ECRM) request the information needed to decide the admissibility of operations from the central instances (server). In this manner, the functionality of the reference monitor is split into a local and a remote component, with the remote instance(s) (ERM) controlling the behavior of the local instance and thus of the entire resources of the respective node, as shown in FIG. 1.

In most cases, however, the simple approach of querying the external instances for each decision procedure is not feasible; provided instead is a combination of requested ERM decisions and security policies, although created and distributed by the ERM, whose enforcement is temporarily delegated for the lifetime of the corresponding system of rules to the ECRM components.

Operations that are relevant to the security of a node can occur on a multitude of objects ranging from files to virtual network connections; depending on the utilized degree of abstraction, this even includes individual accesses to storage cells. All these accesses must suffice one or a multitude of security policies.

In order to not overload the controlling external instances (ERM), it is advantageous to delegate part of the enforcement of the security policies. Storage accesses are an example of such type ECRM delegation; initial access is controlled by the ECRM, whereas further enforcement of the security policy is carried out by protection mechanisms locally embedded in the existing hardware (in the case of realizing the ECRM in software, these hardware protection mechanisms are the only protection of the ECRM itself against tampering by other processes).

A similar mechanism should be employed to limit the scope of the necessary communication with the controlling instances (ERM). The ERM nodes establish a database of rules for decisions relating to the security policy.

For some classes of decisions, which occur relatively seldom or require human interaction, direct involvement of the ERM for each individual decision is justified. An example of such a type of instance is a user log-in event on a node which is directly controlled by an ERM.

For other classes of operations, temporary delegation of the decisions in individual cases is necessary. In these cases, an ECRM either requests, periodically or on the basis of certain occurrences, the policy rules which form the basis for all decisions. An example of this are the rules relating to the admissibility and the content of network connections.

One event which leads to querying one or a multitude of ERMs is processing an operation involving an object or a subject and in which the security policy rules temporarily delegated to the ECRM do not apply directly or derived (indirectly).

Securing an individual node without other connections other than to one ERM or to a multitude of ERMs constitutes a degenerated case, which however can also be modeled by imaging on the ERM rules the security policies locally implemented for the node.

As a result of this, requirement 1 (“The control mechanism required by the reference monitor should be secured against tampering from the outside.”) is met for a distributed system as both the authentication database and the audit subsystem are located outside the control of an attacker as long as the enforcement mechanism is in each case also secured against tampering from the outside. The physical security of the ERM is assumed; due to the use of formal logic of the first order, realization of the system of rules is verifiable and evaluable for the fulfillment of guaranteed characteristics and, therefore, also fulfills requirement 3.

On the other hand, requirement 3 cannot be fulfilled on the ECRM-controlled nodes on the basis of retrofitted operating systems. The main reason for this is that requirement 2 cannot be fulfilled by the whole system due to the complexity and the unknown error conditions of such type retrofitted operating systems. An attacker can obtain control of the data or the mode of function of operating system components with high privileges incognito.

However, fulfillment of requirement 2 can for the most part be met by utilizing cryptographic mechanisms for data objects inside the ECRM and moving at least critical execution paths inside the ECRM.

If key material is stored solely outside the user's control domain and outside the surrounding operating systems, it can be ensured in this manner that any access to objects is controlled and dominated by the ECRM and therefore by the relevant ECRM even after the surrounding operating system has been compromised.

In this manner a frequently neglected security problem is resolved, notably accessing storage media when the security mechanism is inactive, e.g. by accessing a file system from a secondary (not controlled) operating system. However, to ensure that each operation actually is controlled, such data objects must be decrypted solely by the ECRM for one given operation at the time of utilization and, moreover, that key material must never be exposed. Even if operations are partly executed inside the ECRM, this does not alter anything regarding the clear separation between decisions relating to policy, which are solely provided by the ECRMs, and decisions relating to policy enforcement. If a commercial or another existing operating system is modified in such a manner to correspond to the requirements mentioned herein, it is necessary to integrate a multitude of enforcement modules at key positions inside the operating system. The number and the design of the required enforcement modules depends primarily on to what degree this operating system already utilizes the reference monitor model locally as the basis of the security mechanisms.

Due to this principle, a distributed system exposes its nodes to adversaries with regard to the programs being utilized, to

the network connections occurring between the nodes, and in particular, however, with regard to physical control.

It must, therefore, be taken into account that an attacker is able to compromise a node that is under its physical dominance, and this regardless of the security measures provided there locally if sufficient resources are available (e.g., analysis of circuit courses by a logic analyzer, analysis of storage content by cryogenic fixation and subsequently analysis by means of a scanning tunnel microscope).

As a consequence of this assessment, another advantageous condition is added, notably restriction of the information on this node which can maximally reach unauthorized persons, in particular, however, restriction of the key material. Data objects, therefore, must be encrypted each with an own code per object, which is allocated solely to this object. This key material must be generated and stored together with the other attributes of an object by the ERM making the respective decision and must be replicated for other ERMs, if required.

A successfully answered request of an ERM occurs in the transmission of the key material to the ECRM via a secure channel, which implements the code to decrypt the data material for the requested operation and uses precisely this operation and then immediately discards the key material in order to prevent any exposure of plain language data and of key material.

For this purpose, each object must be provided with a marking respectively a label, which associates the object unequivocally with a set of data of one EAD or of a multitude of EADs (external authentication database=authentication database inside the external instance).

For data objects of limited length, this marking can be composed at least partially of a cryptographic hash value, permitting consolidation of a multitude of copies with identical content based on the system of rules regardless of the storage site or the replication of the data objects.

For other types of objects without such type characteristics, markings must be generated which need only be minimally unequivocal as a request. Creation and, if need be, classification of the marking inside the partially ordered sets of type and identity always occurs by the ERM.

Desired additional information is the so-called audit information which can be included with the aid of an audit subsystem. It relates to the ability to trace the data objects and their distribution paths. Furthermore, it comprises information about channels from one subject to another employed to transport data; this also includes the event that all the participating subjects possess the necessary authorization.

In order to obtain this information, at least the information relating to the subject acting as a predecessor of a transmission or as the source of the replication must be available. In this case, this type of information must be protected against tampering as part of the marking of an object. As can be easily seen, a “nonce” (i.e. a coincidental value that may occur precisely for a single transaction, each recurrence of a nonce is equivalent to detection of a replay) suffices to link the identities of the subject that requested access to an object or that requested the operation on an object to the last accessing subject and to encrypt this information using a key known only to the ERM(s).

The result of these steps can now be entered in the marking of the object as soon as the object is copied or otherwise transmitted. The resulting object marking has to be transmitted to the ERM(s) as part of an ECRM's rule request for an object or for an operation. The existence of the nonce permits detection of replays. Other attempts to copy components of the object marking are futile as per definition the marking of each single object is unequivocal.

As previously described, a secure distributed system must also fulfill requirement 1, i.e. the control mechanism required by the reference monitor must be secured against tampering from the outside. This assumption is deemed as fulfilled in most regular operating systems following a conventional reference monitor concept as the hardware security mechanisms for storage administration guarantee that these security mechanisms realize division into at least a regular user mode and a supervisor mode in which transition between the modi is only possible at well-defined points (gates, traps) which are controlled by the operating system kernel.

The main problem of this assumption is that a combination of such type hardware support and the operating system does not differentiate between different levels of protection worthiness and confidentiality in the supervisor mode and that the volume of program codes operating with such type maximum privileges is quite large, at least cannot be verified and validated as required.

Therefore, every module located in the supervisor mode (also called kernel mode) has complete and uncontrolled access to all the local resources of a node, e.g. by direct manipulation of storage areas, devices, modification of other components of the operating system, etc. Apparently such risks also threaten the reference monitor itself. The direct consequence of this design decision is the requirement to subject all the program codes operating in the supervisor mode to the verification and validation of requirement 3.

Although few operating systems were subjected to evaluation standards, such as the Trusted Computer System Evaluation Criteria (TCSEC) or the Common Criteria for Information Technology (ITSEC), the functionality assurance obtained thereby can only correspond to a fleeting glance at the Trusted Computing Base (TCB).

However, even if these requirements are fulfilled, there still remains the problem of physical tampering, e.g. by modification of operating system components even while the system is not running or by tapping the electromagnetic-signals of relevant processes (so-called in-circuit emulators).

Based on this background, considerable efforts have been undertaken in recent years with the aim of preventing physical manipulation of hardware components. The result of these efforts are so-called secure coprocessors.

These devices are highly integrated, closed computer systems which have an autonomous central unit (CPU), storage, memory and a completely autonomous, minimal operating system. In the case of cryptographic coprocessors, cryptographic algorithms are also implemented as hardware along with true random number generators and autonomous real-time clock systems.

The features of such coprocessors relevant for this representation are enclosed in a tamper-resistant housing which at least makes attacks on device contents more difficult or impossible for an attacker equipped with inadequate resources. When tampering attempts are detected, such type devices destroy themselves (realized at least by erasing all storage content that might contain identification features, authentication features or key material).

Secure coprocessors may only communicate with the outside world, in particular with their host system, by means of a narrow and well-defined interface. This, in combination with the moderate complexity of a coprocessor system and the fact that no administrative access to the coprocessor needs to be granted to the outside, permits careful verification and validation of the coprocessor, preferably using formal methods which should also take the actual hardware design into account.

If such type secure coprocessors are assumed as given, the required functionality of an ECRM can be realized completely inside the secure coprocessor. Therefore requirements 1 to 3 are fulfilled even in a distributed system.

A secure communication channel between the ECRM and the ERM can be realized in an exemplary manner with the aid of hybrid key encryption schemes. The use of symmetrical processes with equivalent cryptographic properties depends on the availability of suited hardware for computing asymmetric cryptographic operations.

It is assumed that at least the self-signed digital signature certificate of one or of a multitude of certification points used for identification and authentication are stored in a tampering-resistant area. In addition, the coprocessor should be capable of generating an asymmetric key pair completely inside the tampering-resistant area and to only expose the public key, whereas all the operations run inside the tampering-resistant area using the secret key.

The ECRM and the ERM(s) intercommunicate only if a certificate or a chain of certificates corresponding to the hierarchy of the policies to be applied for the participating parties of the communication are present and valid.

As possibly a multitude of parties with different interests may participate when utilized in a distributed system, a trustworthy third instance should guarantee the integrity of the coprocessors and the certification keys of the used certification points.

An ECRM's request for a rule or a multitude of rules occurs with the aid of a policy data request protocol (PRDP), which transmits the description of the operation and the identities the participating subjects and objects via a secure connection, which contains the integrity, confidentiality and mutual identification. For the latter, an active verification against revocation schemes is even additionally provided.

The ERM(s) reply or replies are transmitted via a channel with the same properties. The replies may answer a superset of the given request, which the ECRM can reuse for the lifetime of the reply following verification of the integrity and authentication of the reply.

If, on the basis of the given rule replies, the data material needs to be encrypted or decrypted, the ECRM decrypts the information provided by the host operating system and returns the thus obtained clear language data, respectively encrypted data thereto. As already discussed in the preceding, this mechanism can be employed for controlling all the decision processes relating to operations inside an operating system.

If possible the ECRM should first store audit data locally. This may occur inside the tampering-resistant areas or stored, tampering-resistantly encrypted for its part, by the host operating system. These audit data can be passed directly on to the relevant ERMs or can be preprocessed based on rules devised by an ERM and then passed on to the ERMs after preprocessing (e.g. combination of a multitude of the same type of results).

Another possible use of these data is utilizing it for detecting attempted or successful attacks on the nodes or the network in which the nodes are located (intrusion detection system, IDS). The required heuristics for decentral preprocessing and passing on of relevant results are transmitted also as a system of rules to the ECRM by the ERM. These rules can operate only as metaoperations on the audit data or lead to active modification of ECRM behavior, thus consequently to active modification of node behavior.

The ECRM does not necessarily have to be realized as hardware, respectively as a secure coprocessor. However, if realized in the form of software, the aforementioned potential risk of tampering has to be accepted.

The mechanism described herein is able to represent with the aid of an automated computer system any describable security model, respectively security policies derived therefrom (without evidence). A multitude of security policies can be combined by querying a multitude of ERMs in a hierarchy (so-called policy domain) respectively by querying all the ERM hierarchies, in whose domain objects are located on which a respective operation should run.

An example is role-based access control in combination with role-based administration mechanisms as well as information flow security policies.

The system described here must be employable beyond the boundaries of organizations and therefore beyond the boundaries of trusted areas. The operator of an ERM does not necessarily have to be trusted by other ERM operators or by ECRM users.

The solution to this problem is analogous to the aforementioned ECRM solution and requires secure coprocessors. All security relevant processing steps, such as the evaluation of rule systems and the derivation of new rules, the generation and processing of protocol data for the PDRP (policy data request protocol), the generation and evaluation of audit data etc., should occur inside the secured area. This assumes a sharp upper limit of the maximum complexity of the mechanism for representing the policy as well as the scope of the data and the rules on which the decisions are based. In this case as well, however, cryptographically secured storage may occur by the host system.

The necessity of being able to conduct verification and validation of the entire mechanism assumes another upper limit of the maximally tolerable complexity.

The ERM must secure the confidentiality and integrity of all policy decisions, the data of the bases of the decisions and the audit data as these data have to be secured in databases which may be located outside the trustworthy environment and are not subject to the direct control of the ERM. Moreover, such type securing realizes separation between possible access to the databases from an operative and an administrative vantage point (e.g. to protect the data). The users of an ERM must trust its operator at least to the extent that the operator guarantees the reliability and the accessibility of the ERM as well as of the databases in a suited manner. Furthermore, it should not be assumed that the ERM operator is attempting to infiltrate the secure area of the coprocessor with considerable cost and criminal energy.

A multitude of coprocessors can be operated in parallel in a host system. This can occur inside a node or in a cluster of nodes. These nodes must be equipped with identical ERM configurations to permit parallel utilization.

Due to the critical dependency of all the nodes of the secure distributed system with regard to the availability of ERMs and to the response times in communication with ERMs, the reliability of the ERM and of the communication paths is of significance.

On the one hand, the ERMs can be arranged hierarchically and, on the other hand, each rule base itself can be replicated over a random number of ERM nodes. Secondary thereto, made rule decisions can be stored as caches by other ERM nodes. A core observation is the so-called “locality of reference”, i.e. the fact that a random process operates only with a very small number of objects at a given time.

Usually the respective objects stem from a certain organization unit. An own local or replicated ERM can be allocated to this organization unit. If a multitude of ERM nodes are implemented in parallel to balance the load, the cryptographically externally stored database can be shared by a multitude of ERM nodes.

A multitude of ERMs can exist inside an organization itself. These ERMs can distribute a common policy or distribute different policies. If such control areas collide, special policies must be defined for areas shared by sub-organizations to off set potentially different regulations.

Access to subjects and objects that stem from different control areas must be routed by the ECRM to the respective ERMs responsible for this area. Allocation of the hierarchy occurs, e.g. by embedding the identities of the subjects and the types in a partially ordered set with the existence of a maximum lower limit as well as a minimum upper limit for each pair of elements of the partially order set, allowing in this manner to refer inside policies to steps within this partially ordered set.

Moreover, the partially ordered set implicitly reflects the identity of the allocated local ERM. A possible embodiment is the realization of a separate routing network with local and wide-area routing protocols, in which local routes are automatically generated by routing algorithms and can in this manner catch partial failures. For reasons of efficiency, wide-area routing protocols, however, require partial manual intervention in order to set optimum routes and connections. The latter, however, may be considered as stable over long periods.

Another embodiment is using the name and route hierarchy given by the domain name system, which may occur by defining own resource records within the framework of the domain name system protocol or by association by means of conventions outside the protocol.

1. A distributed system comprising a multitude of computer units, so-called nodes, interconnected via a network and in each of which a local monitoring unit is provided for application of at least one security policy incumbent on the respective node, said nodes being connected inside said network to at least one supervisor monitoring unit, in the form of a so-called external reference monitor, short ERM, in which systems of rules relating to the security policies of all said nodes or of at least one group of said nodes are storable,
wherein said local monitoring unit is a reference monitor (ECRM=externally controlled reference monitor), which controls, on the operation system level of the respective node, all operations within said node subject to said system of rules, which is implemented in said reference monitor (ECRM) of said respective node and is represented in the form of syntactic elements and is applicable, subject to the formal logic of the first order in order to obtain self-consistent decisions.

2. The distributed system according to claim 1,
wherein provided are a multitude of supervisor monitoring units in the form of external reference monitors (ERM), each containing different security policies, which are retrievable by said ECRMs of said nodes.

3. The distributed system according to claim 1 or 2,
wherein said reference monitor (ECRM) performs the operations between objects and subjects, with the term “object” being singly describable by the following identification features without being limited thereto:
file, executable file, data file, list, connection, virtual connection, datagram, interprocess communication message, device, physical connection, memory segment,
the term “subjects” being singly describable by the following identifying features without being limited thereto:
user, process, application program, node, network, network connection, bus connection, and
the term “operation” being singly describable by the following identifying features without being limited thereto:
compiling a file, reading a file, writing a file, overwriting a file, adding a file, deleting a file, reading the metainformation of a file, writing the metainformation of a file, reading a list, compiling a list, searching in a list, deletion of a list, creating a memory segment, reading a memory segment, writing a memory segment, deleting a memory segment, opening a device, reading the data of a device, writing the data on a device, reading the metadata of a device, writing the metadata on a device, shutting down a device, transmitting interprocess communication messages, reception of interprocess communication messages, transmitting of datagrams, reception of datagrams, creating a virtual connection, transmitting of data via a virtual connection, receiving data via a virtual connection, removing a virtual connection.

4. The distributed system according to claim 3,
wherein all subjects and objects relating to individual said nodes are labeled, respectively initialed, in such a manner that said subjects or objects can be identified during transmission from one node to another node subject to the security policy incumbent thereon.

5. The distributed system according to one of the claims 2 to 4,
wherein said multitude of supervisor monitoring units (ERM) inside said distributed system is structured hierarchically.

6. The distributed system according to one of the claims 1 to 5,
wherein said ERM is designed in such a manner that in addition to said stored system of rules, information relating to authentication (EAD) and authorization of the operations running inside each individual node is stored in said ERM.

7. The distributed system according to one of the claims 1 to 6,
wherein provided, in addition to said system of rules stored inside said ERM, is an audit subsystem which detects and records communication between individual said nodes and said ERM and/or operations running between subjects and objects occurring inside each individual said node.

8. The distributed system according to one of the claims 1 to 7,
wherein provided in each said node and/or in at least one said ERM is a cryptographic unit, which encrypts at least one exchange of information between each individual, said node and said at least one ERM using an authentication process.

9. The distributed system according to one of the claims 1 to 8,
wherein said supervisor monitoring unit is designed as a secure coprocessor.

10. The distributed system according to claim 9,
wherein said secure coprocessor comprises, in addition to said system of rules, an authentication unit as well as an audit subsystem.

11. The distributed system according to claim 9 or 10,
wherein said secure coprocessor is an instance which is isolated from the remaining said node and which is in itself autonomously secure against manipulation and which is able to verify its own integrity and the integrity of all objects and subjects of said node and to destroy itself if manipulations which impair said integrity are detectable.

12. A process for applying a security policy in a multitude of interconnected computer units, so-called nodes, provided in each of which is a local monitoring unit, which is connected inside said network to at least one supervisor monitoring unit existing therein, in which systems of rules are stored relating to the security policy of all said nodes or at least to one group of said nodes,
wherein the system of rules determining said security policy is retrieved from said at least one supervisor monitoring unit and is stored and processed inside said node in such a manner that said system of rules controls, on the operating system level of said node, all operations inside said node subject to said system of rules, with said system of rules comprising and being represented as a command code respectively decision code composed of syntactical elements and said system of rules being applied, on the basis of the principles of the formal logic of the first order, to obtain self-consistent decisions.

13. The process according to claims 12,
wherein said system of rules retrieved from a node by said supervisor monitoring unit is stored in a reference monitor (ECRM=externally controlled reference monitor) which operates on the operating system level inside said node.

14. The process according to claims 12 or 13,
wherein a multiplicity of external monitoring units, so-called external reference monitors (ERM), are provided, in each of which different security policies are stored which are communicated to predetermined nodes.
